(19) United States
(12) Patent Application Publication
(10) Pub. No.: US 2004/0256430 A1
(43) Pub. Date: Dec. 23, 2004

(54) Fastening device for bicycle rack

(76) Inventor: Chiu Kuei Wang, Miaoli Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/600,463

(22) Filed: Jun. 23, 2003

(51) Int. Cl. B60R 9/00; B60R 11/00

(52) U.S. Cl. 224/520; 224/924

(57) ABSTRACT

A bicycle rack includes two tubes each have a rod extending from a first end thereof and a clamp mechanism is connected to each rod. Two retainers are respectively connected to two respective insides of the two tubes and located at two respective second ends of the two tubes. The two retainers each have a recess so as to clamp a frame with a connection sphere between the two retainers. Each clamp mechanism has two clamp members and a clamp plate extends from one of the clamp members and the other clamp member has a protrusion which is engaged with one of holes defined in the clamp plate. The clamp plate is located in parallel with the rod so that it can be pulled without interference with the rod.

### FIELD OF THE INVENTION

The present invention relates to a bicycle rack connected to a rear end of a vehicle and a fastening device of the bicycle rack firmly connected to the connection frame connected at the rear end of the vehicle.

### BACKGROUND OF THE INVENTION

A conventional bicycle rack 70 for carrying bicycles on the rear end of a vehicle is shown in FIG. 5 and generally includes two tubes each having clamp members 73 connected to a lower end thereof and two stretch links 74 and 75 are connected between the two tubes. Each clamp member 73 includes a recess 731 so that a connection sphere 62 connected to a frame 60 is embraced in the two recesses 731. A rod 72 extends from a side of each of the two tubes and a clamp mechanism 70 is connected to each of the rods 72 so as to clamp bicycle frames by the two clamp mechanisms 721. The clamp mechanisms 721 each have a sleeve 722 for mounting onto the rod 72 corresponding thereto and two clamp plates 723 are connected to the sleeve 722 so as to form a passage 724 through which a top tube of a bicycle frame extends. A fastening belt 725 is connected to the two clamp plates 723 which are adjusted by pulling the fastening belt 725.

Nevertheless, the clamp members 73 are not able to clamp the sphere 62 firmly so that the whole bicycle rack 70 shakes during riding. In addition, when pulling the fastening belt 725, the users' hand is interrupted by the rod 72 so that it is inconvenient for the users to adjust the clamp plates 723.

### SUMMARY OF THE INVENTION

In accordance with one aspect of the present invention, there is provided a bicycle rack which comprises two tubes each having a rod extending from a first end thereof and a clamp mechanism is connected to each rod. Two stretch links are connected between the two tubes. Two retainers are respectively connected to two respective insides of the two tubes and located at two respective second ends of the two tubes. The two retainers each have a recess so as to clamp a frame with a connection sphere between the two retainers.

The primary object of the present invention is to provide a fastening mechanism for the bicycle rack and which prevents the bicycle rack from shaking during riding.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle rack of the present invention;

FIG. 2 is an exploded view to show one of the two clamp mechanisms is to be connected to the rod of the bicycle rack of the present invention;

FIG. 3 shows a fastening device of the bicycle rack of the present invention;

FIG. 4 shows the frame with the connection sphere is clamped by the fastening device, and

FIG. 5 shows a conventional bicycle rack.

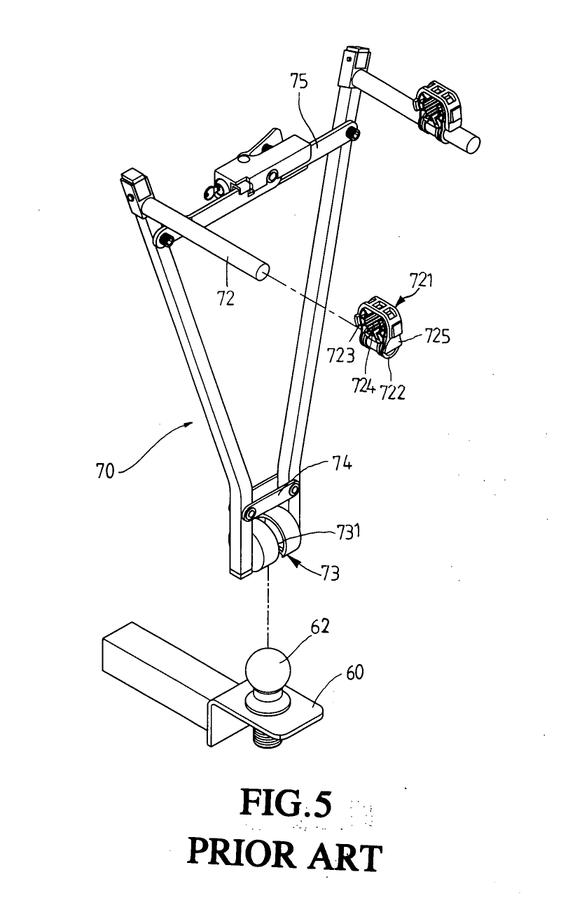

### DETAILED DESCRIPTION OF THE PREFERRED EMBODIMENT

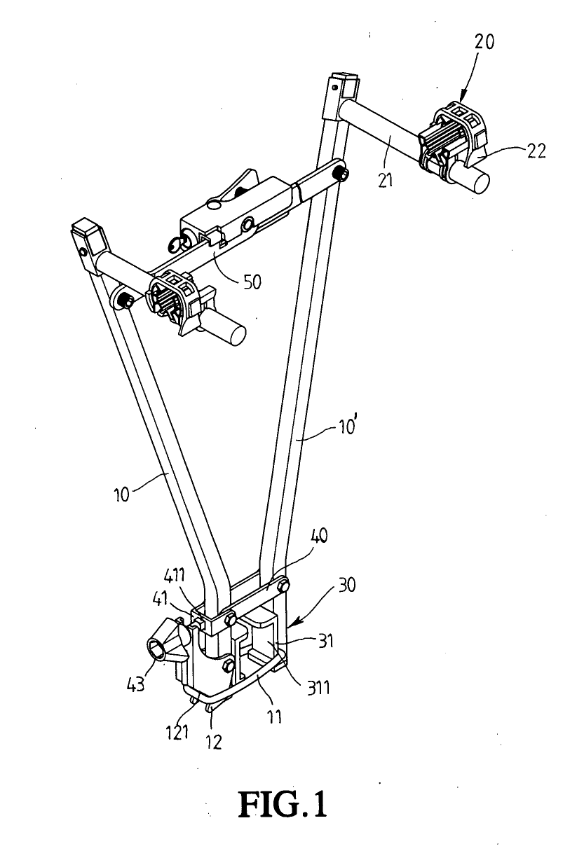

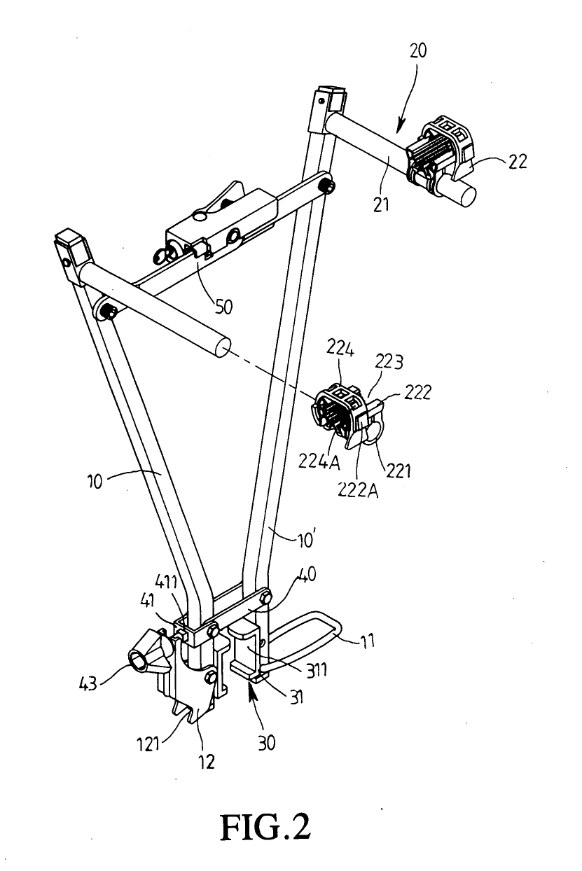

Referring to FIGS. 1 and 2, the bicycle rack the present invention comprises a bicycle rack which comprises two tubes 10, 10′ each having a rod 21 extending from a first end thereof and a clamp mechanism 20 is connected to each rod 21. Two stretch links 40, 50 are connected between the two tubes 10, 10′ so as to stretch the two tubes 10, 10′ apart. The stretch link 40 is a U-shaped frame and the two tubes 10, 10′ are pivotably connected between two legs of the U-shaped frame. Each of the clamp mechanism 20 includes a sleeve 221 for being mount on the rod 21 and two clamp members 222 are connected to the sleeve 221. A space 223 is defined between the two clamp members 222 and a top tube (not shown) of a bicycle can be clamped between the two clamp members 222. A clamp plate 224 extends from one of the clamp members 222 and has a plurality of holes 224A. A protrusion 222A extends from the other clamp member 222 and is engaged with one of the holes 224A. A longitudinal axis of the clamp plate 224 is parallel with an axis of the rod 21 corresponding thereto, so that when pulling the clamp plate 224 to engage another hole 224A with the protrusion 222A, the rod 21 will not interrupt the action of the pulling.

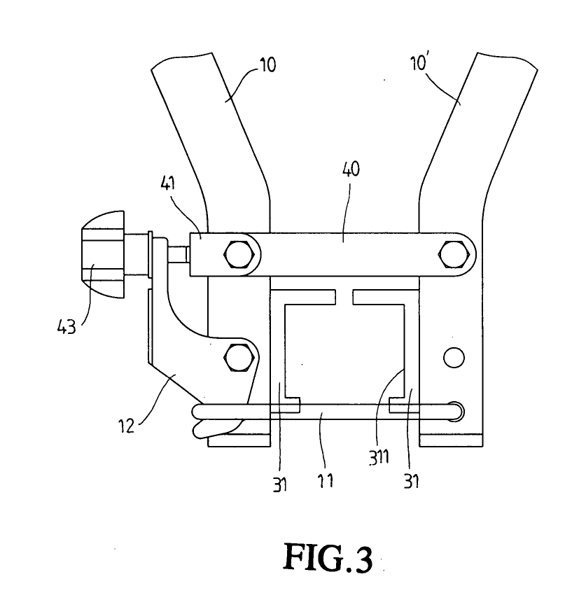

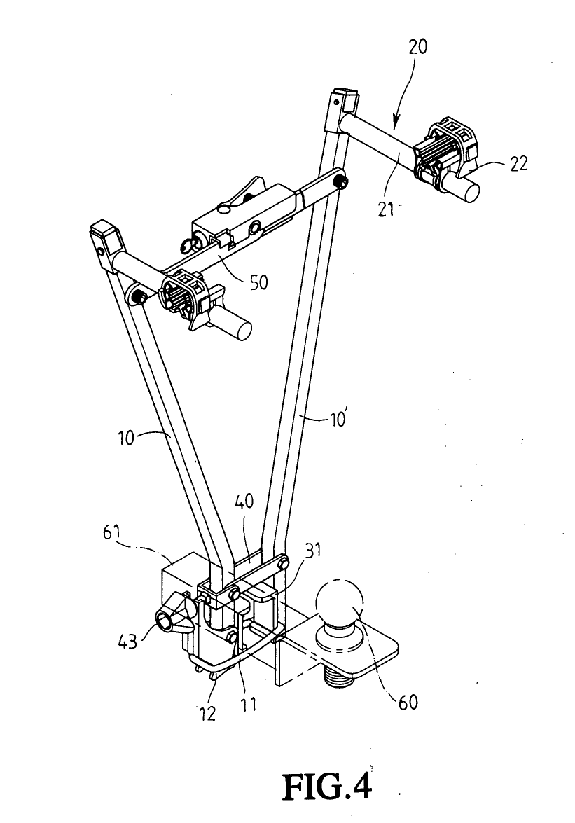

Further referring to FIGS. 3 and 4, a fastening device 30 including two retainers 31 which are respectively connected to two respective insides of the two tubes 10, 10′ and located at two respective second ends of the two tubes 10, 10′. The two retainers 31 each have a recess 311 so as to clamp a frame 61 with a connection sphere 60 between the two retainers 31. A loop 11 is pivotably connected to the tube 10′ and an engaging member 12 is pivotably connected to the other tube 10. The engaging member 12 includes a groove 121 defined in a first end thereof and the loop 11 can be pivoted to engage with the groove 121so as to pull the two tubes 10, 10′ toward each other. A screw 43 extends through a second end of the engaging member 12 and is threadedly connected to a connection section for connecting the two legs of the U-shaped link 40. A pivotal point for connecting the engaging member 12 to the tube 10 is located between the groove 121 and the screw 43. By screwing the screw 43, the first end of the engaging member 12 is pushed away from the tube 10 so that the frame 61 is firmly clamped by the retainers 31.

While we have shown and described the embodiment in accordance with the present invention, it should be clear to those skilled in the art that further embodiments may be made without. departing from the scope of the present invention.

What is claimed is:

1. A bicycle rack comprising:
two tubes (10, 10′) each having a rod (21) extending from a first end thereof and a clamp mechanism (20) connected to each rod (21), two stretch links (40, 50) connected between the two tubes (10, 10′);
two retainers (31) respectively connected to two respective insides of the two tubes (10, 10′) and located at two respective second ends of the two tubes (10, 10′), the two retainers (31) each having a recess (311) so as to be adapted to clamp a frame (60) with a connection sphere between the two retainers (31).

2. The bicycle rack as claimed in claim 1 further comprising a loop (11) pivotably connected to one of the two tubes and an engaging member (12) pivotably connected to the other tube (10), the loop (11) removably engaged with the engaging member (12) so as to pull the two tubes (10, 10′) toward each other.

3. The bicycle rack as claimed in claim 2, wherein the engaging member (12) includes a groove (121) defined in a first end thereof and the loop (11) is engaged with the groove (121).

4. The bicycle rack as claimed in claim 3, wherein a screw (43) extends through a second end of the engaging member (12) and is threadedly connected to the stretch link (40), a pivotal point for connecting the engaging member (12) to the tube (10) is located between the groove (121) and the screw (43).

5. The bicycle rack as claimed in claim 1, wherein each of the clamp mechanism (20) includes a sleeve (221) for being mount on the rod (21) and two clamp members (222) connected to the sleeve (221), a clamp plate (224) extending from one of the clamp members (222) and having a plurality of holes (224A), a protrusion (222A) extending from the other clamp member (222) and engaged with one of the holes (224A), a longitudinal axis of the clamp plate (224) being parallel with an axis of the rod (21) corresponding thereto.

6. A bicycle rack comprising:
two tubes (10, 10′) each having a rod (21) extending from a first end thereof and a clamp mechanism (20) connected to each rod (21), two stretch links (40, 50) connected between the two tubes (10, 10′), each of the clamp mechanism (20) including a sleeve (221) for being mount on the rod (21) and two clamp members (222) connected to the sleeve (221), a clamp plate (224) extending from one of the clamp members (222) and having a plurality of holes (224A), a protrusion (222A) extending from the other clamp member (222) and engaged with one of the holes (224A), a longitudinal axis of the clamp plate (224) being parallel with an axis of the rod (21) corresponding thereto, and
two retainers (31) respectively connected to two respective insides of the two tubes (10, 10′) and located at two respective second ends of the two tubes (10, 10′), the two retainers (31) each having a recess (311) so as to be adapted to clamp a frame (60) with a connection sphere between the two retainers (31).

7. The bicycle rack as claimed in claim 6 further comprising a loop (11) pivotably connected to one of the two tubes and an engaging member (12) pivotably connected to the other tube (10), the loop (11) removably engaged with the engaging member (12) so as to pull the two tubes (10, 10′) toward each other.

8. The bicycle rack as claimed in claim 7, wherein the engaging member (12) includes a groove (121) defined in a first end thereof and the loop (11) is engaged with the groove (121).

9. The bicycle rack as claimed in claim 7, wherein a screw (43) extends through a second end of the engaging member (12) and is threadedly connected to the stretch link (40), a pivotal point for connecting the engaging member (12) to the tube (10) is located between the groove (121) and the screw (43).
